(19) United States
(12) Patent Application Publication
(10) Pub. No.: US 2008/0236483 A1
(43) Pub. Date: Oct. 2, 2008

(54) METHOD FOR LOW TEMPERATURE THERMAL CLEANING

(76) Inventors: Jun SONOBE, Tsukuba-shi (JP); Yudai TADAKI, Tsukuba (JP); Takamitsu SHIGEMOTO, Akashi-shi (JP); Jean-Marc GIRARD, Paris (FR)

Correspondence Address: AIR LIQUIDE;Intellectual Property, 2700 POST OAK BOULEVARD, SUITE 1800, HOUSTON, TX, 77056, US

(21) Appl. No.: 12/023,679

(22) Filed: Jan. 31, 2008

Related U.S. Application Data
(63) Continuation-in-part of application No. 11/967,603, filed on Dec. 31, 2007.
(60) Provisional application No. 60/908,381, filed on Mar. 27, 2007.
(60) Provisional application No. 60/951,384, filed on Jul. 23, 2007.
(60) Provisional application No. 60/984,286, filed on Oct. 31, 2007.

(51) Int. Cl. B05C 11/00; B08B 3/00

(52) U.S. Cl. 118/70; 134/30

(57) ABSTRACT

Methods and apparatus for cleaning undesired substances from a surface in a semiconductor processing chamber. A gas mixture containing a fluorine source and an oxygen source is pre-treated to contain active fluorine species. The pre-treated mixture is stored for a time in a gas storage device, and then introduced to a semiconductor processing chamber. Prior to introduction of the pre-treated gas, the temperature in the chamber is lowered to a temperature equal to or lower than the normal operating temperature. Undesired substances are removed or cleaned through chemical reaction with the pre-treated gas mixture, without the generation of a plasma or a high temperature condition in the chamber.

### CROSS REFERENCE TO RELATED APPLICATIONS

The present application claims the benefit of U.S. Provisional Application Ser. No. 60/908,381, filed Mar. 27, 2007, U.S. Provisional Application Ser. No. 60/951,384, filed Jul. 23, 2007, and U.S. Provisional Application Ser. No. 60/984,286, filed Oct. 31, 2007, and U.S. Non-Provisional application Ser. No. 11/967,603, filed on Dec. 31, 2007, all herein incorporated by reference in their entirety for all purposes.

### BACKGROUND

1. Field of the Invention

This invention relates generally to the field of semiconductor fabrication. More specifically, the invention relates to a method of cleaning undesired substances from at least one surface of a semiconductor processing chamber.

2. Background of the Invention

Deposition of materials onto a silicon substrate, either through Chemical Vapor Deposition (“CVD”) or through Atomic Layer Deposition (“ALD”), are common steps in the manufacture of integrated circuits. Due to the nature of these deposition techniques, the material intended to be deposited on the substrate is often also inadvertently deposited on surfaces within the semiconductor processing chamber. These inadvertent deposits of undesired material on the various surfaces of the semiconductor processing chamber must be periodically cleaned; otherwise they may accumulate or affect later deposition stages performed in the same chamber. Periodic cleaning of the entire chamber is therefore necessary to maintain high product quality, and it is preferable for a cleaning process to have a high cleaning rate so as to keep tool downtime at a minimum and maximize tool throughput.

Several methods of chamber cleaning are known. Wet chemical cleaning of the chamber is possible, but as it requires the disassembly of the reaction chamber, it requires high labor costs and long downtime. So called dry cleaning involves introducing a gas mixture into the chamber, which reacts with the undesired substances, and which then is easily removed through a purging step. Some dry cleaning methods employ microwave generated plasmas in the chamber to disassociate the gas mixture into reactive species that clean the deposited materials through chemical reaction. When a plasma is required, areas in the chamber that are not in direct contact with the plasma will not be effectively cleaned. Also, over time the plasma may negatively affect the chamber's condition by causing damage or deterioration of the chamber and any components stored within. Disassociation of the reactants upstream of the chamber with a remote plasma system is possible, but requires additional tools and equipment to be installed and operated by the tool owner, which is costly and which may increase the overall cleaning downtime.

In the absence of a plasma, it is possible to increase the chamber temperature so as to attempt to promote the thermal disassociation of the cleaning gas mixture. This high temperature type cleaning is less commercially feasible as heating the chamber increases the overall cleaning step downtime, and may also damage the chamber and components stored within. Additional equipment may also be necessary for these types of heating steps.

Consequently, there exists a need for a chamber cleaning method which does not require a plasma in the chamber, which can be performed at relatively low temperatures, and which requires a minimum of additional equipment to be installed upstream of or operated in conjunction with, the semiconductor processing tool.

### BRIEF SUMMARY

Novel formulations and methods for the low temperature cleaning of a semiconductor processing chamber are described herein. The disclosed methods and formulations utilize a pretreated cleaning gas mixture which, when introduced to a semiconductor processing chamber at a low temperature, removes undesired substances from the chamber surfaces. The particular formulation and combination of the cleaning gas mixture may vary.

In an embodiment, a semiconductor processing chamber containing at least one undesired substance on a surface within the chamber is provided. A first gas mixture, which contains both a fluorine source and an oxygen source, is pre-treated to form a pre-treated first gas mixture which contains active fluorine species. The pre-treated first gas mixture is introduced into a gas storage system. The temperature of the chamber is then reduced to a first temperature, and the pretreated first gas mixture is allowed to flow from the gas storage system and into the chamber. At least part of the undesired substances on a surface of the chamber is then removed or cleaned from that surface through a chemical reaction which occurs between the pre-treated first gas mixture and the undesired substance, thereby forming reaction products. The cleaning of the chamber is performed without generating a plasma in the chamber, and without raising the temperature of the chamber above the first temperature.

Other embodiments of the invention may include, without limitation, one or more of the following features:
the first gas mixture contains less than about 99%, and more preferably between about 50% and about 80%, by volume, of the fluorine source;
the first gas mixture contains less than about 99%, and more preferably between about 20% and about 50%, by volume, of the oxygen source;
the fluorine source comprises at least one of nitrogen trifluoride, nitrosyl fluoride, nitoryl fluoride, fluorine nitrate, sulfur hexafluoride, fluorine, and mixtures thereof;
the oxygen source comprises at least one of nitric oxide, nitrous oxide, nitrogen dioxide, oxygen, ozone, water, silicon dioxide, nitrosyl fluoride, nitrogen trifluoride oxide and mixtures thereof;
the pre-treating of the first gas mixture comprises introducing the first gas mixture into a reactor, reacting the first gas mixture in the reactor to disassociate fluorine from the fluorine source and create active fluorine species in the gas mixture, cooling the first gas mixture to about ambient temperature, and introducing the first gas mixture to a gas storage system for storage;
the reactor is not in fluid communication with the semiconductor processing chamber;
the first gas mixture is reacted in the reactor by either heating the first gas mixture to a temperature between about 300° C. and about 1000° C., or by exposing the first gas mixture to a plasma;
the first gas mixture is reacted in the reactor by heating the first gas mixture to a temperature between about 400° C. and about 700° C.;
the first gas mixture is pre-treated at a location substantially removed from the location of the chamber;
the first gas mixture is pre-treated at least about a day before the pre-treated first gas mixture is introduced into the chamber;
the pre-treated first gas mixture is stored in the gas storage device for at least about 12 hours before it is introduced into the chamber;
the pre-treated first gas mixture is introduced into the chamber at a rate between about 1 and about 10 standard liters per minute;
the undesired substance comprises at least one of SiO₂, SiN, SiON, polysilicon, amorphous silicon, microcrystal silicon, and mixtures thereof;
the first temperature is between about 50° C. and about 500° C., and more preferably between about 50° C. and about 300° C.;
the undesired substance is phosphosilicate glass (PSG) or borophosphosilicate glass (BPSG);
the undesired substance comprises at least one of Ta, TaN, TaO, TaON, and mixtures thereof;
the undesired substance comprises at least one of Ti, TiN, TiO, TiON, and mixtures thereof;
the undesired substance comprises at least one of ZrO₂, ZrN, ZrON, ZrSiN, ZrSiON, ZrSiOx, and mixtures thereof;
the undesired substance comprises at least one of HfO₂, HfN, HfON, HfSiN, HfSiON, HfSiOx, and mixtures thereof; and
the undesired substance comprises at least one member selected from the group consisting of W, WOx, WNx, WON, WSiO, WSiN, WSiON and, mixtures thereof.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 illustrates a schematic view of one embodiment, according to the current invention, of a method for cleaning a semiconductor processing chamber.

### DESCRIPTION OF PREFERRED EMBODIMENTS

Generally, embodiments of the current invention relate to a method for low temperature cleaning of a semiconductor processing chamber, by introducing a pre-treated gas mixture containing active fluorine species into the processing chamber at a temperature equal to or lower than the normal operating temperature of the chamber. The pre-treated gas mixture removes or cleans at least one undesired substance from a surface in the chamber at the lower temperature and without the generation of an in chamber plasma being necessary.

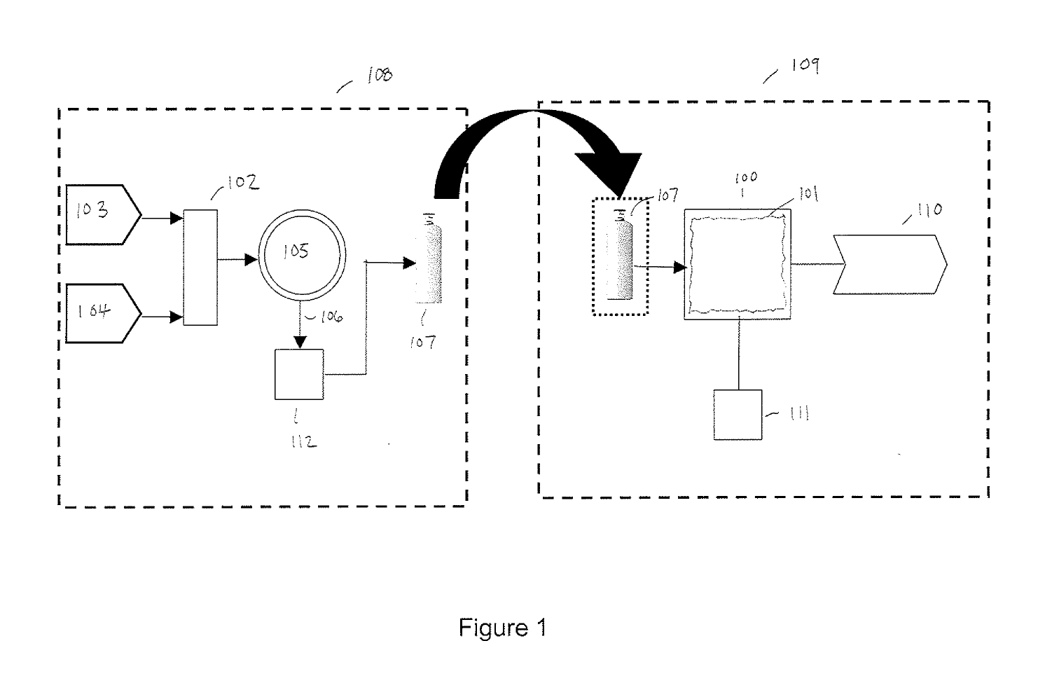

Referring now to FIG. 1, embodiments of the method according to the current invention are described hereinafter. A semiconductor processing chamber 100 contains at least one undesired substance 101 on at least one surface within the chamber 100. The undesired substance 101 may be a by-product of a semiconductor manufacturing step, such as a chemical vapor deposition (“CVD”) step, including low pressure CVD (“LPCVD”) steps and plasma enhanced CVD (“PECVD”) steps, or an atomic layer deposition (“ALD”) step. In addition to depositing a material on a silicon substrate, these manufacturing steps will also deposit the material on other surfaces which are exposed within the chamber. Depending on the specific semiconductor manufacturing step performed in chamber 100, the undesired substance 101 may vary.

In some embodiments, the undesired substance 101 may contain silicon. For instance, the undesired substance 101 may be SiO₂, SiN, SiON, polysilicon, amorphous silicon, microcrystal silicon, or mixtures of these, which may be left behind in the chamber 100 from a semiconductor manufacturing process, for instance, LPCVD.

In some embodiments, the undesired substance 101 may be a form of glass, such as phosphosilicate glass (“PSG”) or borophosphosilicate glass (“BPSG”), which may be left behind in chamber 100 from a semiconductor manufacturing process, for instance, LPCVD.

In some embodiments, the undesired substance 101 may contain a metal. For instance, the undesired substance may be tantalum based (e.g. Ta, TaN, TaO, TaON), titanium based (e.g. Ti, TiN, TiO, TiON), zirconium based (e.g. ZrO₂, ZrN, ZrON, ZrSiN, ZrSiON, ZrSiOₓ,) hafnium based (e.g. HfO₂, HfN, HfON, HFSiO, HfSiN, HfSiON, HfSiOₓ,), tungsten based (e.g. W, WOx, WNx, WON, WSiO, WSiN, WSiON) or mixtures of these which were left behind in the chamber 100 from a semiconductor manufacturing process, for instance, ALD.

One of skill in the art would recognize that the formulas described above, and in particular the value of variable x, can vary according to the stoichiometry of the material and the oxidation state of the elements. One of skill in the art would also recognize that other undesired substances 101 would be possible depending upon the particular semiconductor manufacturing process carried out in chamber 100.

A first gas mixture 102 which comprises a fluorine source 103 and an oxygen source 104 is pre-treated to form a pre-treated first gas mixture 106 which contains active fluorine species.

The relative amounts of fluorine source 103 and oxygen source 104 contained in the first gas mixture 102 may vary. Generally, the amount of fluorine source 103 in the first gas mixture 102 is stoichiometrically greater than or equal to the amount of the oxygen source 104. The first gas mixture 102 may also contain an inert type gas (e.g. argon, nitrogen, helium) as a remainder. In some embodiments, there may be less than about 99%, by volume, of the fluorine source 103, and less than about 99%, by volume, of the oxygen source 104. In some embodiments, the first gas mixture 102 may contain between about 50% and about 80%, by volume, of the fluorine source, and between about 20% and about 50%, by volume, of the oxygen source 104. In one embodiment, there may be about an equal amount of both the fluorine source 103 and oxygen source 104.

The composition of the fluorine source 103 may also vary. In some embodiments the fluorine source 103 may be one of nitrogen trifluoride, nitrosyl fluoride, nitoryl fluoride, fluorine nitrate, sulfur hexafluoride, fluorine, or mixtures thereof. Likewise, the composition of the oxygen source 104 may vary. In some embodiments the oxygen source 104 may be one of nitric oxide, nitrous oxide, nitrogen dioxide, oxygen, ozone, water, silicon dioxide, or a mixture thereof. In some embodiments, the oxygen source 104 may also contain a fluoride, for instance oxygen source 104 may be nitrosyl fluoride or nitrogen trifluoride oxide.

In one embodiment, the first gas mixture 102 may be a mixture of fluorine and nitrosyl fluoride, which may be obtained by through the following reaction:

F_{2(excess)}+NO→F₂+FNO

In this embodiment, fluorine acts as the fluorine source 103, and nitrosyl fluoride acts as the oxygen source 104. The first gas mixture 102 may be prepared or mixed in a conventional way, such mixing the F₂ and NO with a gas mixing or blending manifold.

In one embodiment, the first gas mixture 102 is pre-treated in a reactor 105, which may be a conventional type reactor such as a pressurized vessel or an enclosed container. The first gas mixture 102 is introduced into reactor 105, where it is reacted to disassociate fluorine from the fluorine source 103, thereby creating active fluorine species in the first gas mixture 102. In some embodiments, the reaction may be a thermal decomposition type reaction, wherein the reactor is heated to a temperature between about 300° C. and about 1000° C., and preferably heated to about 500° C. In some embodiments, the reaction may be initiated by exposing the first gas mixture 102 to a plasma in order to disassociate the fluorine.

In some embodiments, the reactor 105 is not in fluid communication with the semiconductor processing chamber 100, in that a continuous fluid flow path between the reactor 105 and the processing chamber 100, such as a flow path created by piping or tubing, is not present. This may be due to the fact that pre-treating of the first gas mixture 102 occurs at a location 108 which is substantially removed from the location 109 of the chamber 100. For instance, the chamber 100 may be located at a semiconductor manufacturing site, while the pre-treating may occur off site at a gas production, storage, or transfill center which is not situated on or within the manufacturing site. In some embodiments, location 108 and location 109 may be about ten miles apart, preferably about 5 miles apart or even more preferably about a mile apart.

After the disassociation type reaction, the pre-treated first gas mixture 106 may be cooled to about ambient temperature by a cooler 112, which may be a conventional type cooler, such as a heat exchanger. The pre-treated first gas mixture 106 is then introduced into a gas storage system 107 for storage. In some embodiments, gas storage system 107 is a conventional gas storage system, for instance, a gas cylinder suitable for the storage of a fluorine containing pressurized gas. Gas storage system 107 may be passivated prior to the introduction of the pre-treated first gas mixture 106. By storing the pre-treated first gas mixture 106 in gas storage system 107, the time between the pretreatment and the use of the pre-treated first gas mixture 106 may be increased. For instance, several days may pass between the pretreating and the use of the pre-treated first gas mixture 106. Typically, after the pre-treated first gas mixture 106 is stored in the gas storage system 107, the gas storage system is moved from location 108, where the pre-treatment occurred to location 109 where the pre-treated gas mixture 106 will be introduced to semiconductor processing chamber 100. Once gas storage system 107 is delivered to location 109, gas storage system 107 is fluidly coupled to the chamber 100 in a conventional manner, so that the pre-treated gas mixture 106 contained in gas storage system 107 may be introduced into chamber 100.

Regardless of the particular semiconductor processing step performed in chamber 100 (e.g. CVD, ALD, etc), the normal operating temperature of chamber 100 is typically high, for instance, chamber 100 may operate at temperatures in excess of 1000° C. In some embodiments, the temperature of the chamber 100 is lowered to a first temperature before the pre-treated gas mixture 106 is introduced into the chamber 100. In some embodiments, the first temperature is between about 50° C. and about 500° C., and preferably between about 50° C. and about 300° C.

After the temperature in chamber 100 is lowered to about the first temperature, the pre-treated first gas mixture 106 is introduced into chamber 100, from gas storage device 107. The flow rate of pre-treated first gas mixture 102 may be between about 1 and about 10 standard liters per minute (slpm).

In some embodiments, first gas mixture 102 was pretreated about one day prior to the time pre-treated first gas mixture 106 is introduced into chamber 100. In some embodiments, the pre-treated first gas mixture 106 is stored in gas storage device 107 for at least about 12 hours before pre-treated first gas mixture 106 is introduced into chamber 100.

Once pre-treated first gas mixture 106 is present in chamber 100, the fluorine species contained in the first gas mixture 102 react with the undesired substances and form reaction products, which may be removed from the chamber 100 via a vent or exhaust line 110. The chamber 100 may be purged by an inert gas 111 (e.g. nitrogen, argon, helium, etc), which is fluidly coupled to the chamber 100, in order to expedite the removal via exhaust line 110.

One of skill in the art would recognize that the specific reactions and the specific reaction products formed would vary depending on several factors, including the undesired substances present in chamber and the specific components of the pre-treated first gas mixture 102. In this manner, the undesired substances 101 are cleaned from the surface of chamber 100, while maintaining the temperature of the chamber 100 at less than the specified first temperature, and without the generation of a plasma in the chamber 100.

### EXAMPLES

The following non-limiting examples are provided to further illustrate embodiments of the invention. However, the examples are not intended to be all inclusive and are not intended to limit the scope of the inventions described herein.

### Example 1

In a thermal cleaning process to remove TiN residue from chamber surfaces, 10% NO was added to NF3 diluted in N2. At 200° C., the mixture provided a clean rate of about 852 angstroms/min (A/min). When the chamber temperature was increased to about 400° C., the clean rate increased to 4000 A/min.

### Example 2

In a thermal cleaning process to remove Si₃N₄, sole NF3 in dilution with N2 would not clean, even at a temperature of about 500° C. However, a mixture 10% NO added to NF3 diluted in N2 produced a clean rate of more than 1000 A/min, at the same 500° C. chamber temperature. At 300° C., a clean rate of about 388 A/min was observed.

### Example 3

In a thermal cleaning process to remove SiN, a mixture of 10% F₂ with 2% NO, and diluted with N2, was introduced into a chamber at 50 torr and 300° C. At these conditions a clean rate of about 1500 A/min was observed.

While embodiments of this invention have been shown and described, modifications thereof can be made by one skilled in the art without departing from the spirit or teaching of this invention. The embodiments described herein are exemplary only and not limiting. Many variations and modifications of the composition and method are possible and within the scope of the invention. Accordingly the scope of protection is not limited to the embodiments described herein, but is only limited by the claims which follow, the scope of which shall include all equivalents of the subject matter of the claims.

What is claimed is:

1. A method for the low temperature cleaning of a semiconductor processing chamber comprising:
a) providing a semiconductor processing chamber, wherein the chamber contains at least one undesired substance on at least one surface within the chamber;
b) pre-treating a first gas mixture comprising a fluorine source and an oxygen source to form a pretreated first gas mixture, wherein the pre-treated first gas mixture comprises active fluorine species;
c) introducing the pre-treated first gas mixture to a gas storage system;
d) reducing the temperature of the chamber to a first temperature;
e) introducing the pre-treated first gas mixture from the gas storage system into the semiconductor processing chamber; and
f) cleaning at least one of the undesired substances from the surfaces of the chamber through chemical reaction between the pre-treated first gas mixture and the undesired substances to form reaction products, without generating a plasma in the chamber or increasing the chamber temperature above the first temperature.

2. The method of claim 1, wherein the first gas mixture comprises:
a) less than about 99% by volume, of the fluorine source;
b) less than about 99% by volume, of the oxygen source; and
c) the remainder as an inert gas.

3. The method of claim 2, wherein the first gas mixture comprises:
a) between about 50% and about 80%, by volume, of fluorine source; and
b) between about 20% and about 50%, by volume, of the oxygen source.

4. The method of claim 1, wherein the fluorine source comprises at least one member selected from the group consisting of:
a) nitrogen trifluoride;
b) nitrosyl fluoride;
c) nitoryl fluoride;
d) fluorine nitrate;
e) sulfur hexafluoride;
f) fluorine; and
g) mixtures thereof.

5. The method of claim 1, wherein the oxygen source comprises at least one member selected from the group consisting of:
a) nitric oxide;
b) nitrous oxide;
c) nitrogen dioxide;
d) oxygen;
e) ozone;
f) water;
g) nitrosyl fluoride;
h) nitrogen trifluoride oxide;
i) silicon dioxide; and
j) mixtures thereof.

6. The method of claim 1, wherein pre-treating the first gas mixture comprises
a) introducing the first gas mixture into a reactor;
b) reacting the first gas mixture in the reactor to disassociate fluorine from the fluorine source and create active fluorine species in the gas mixture;
c) cooling the first gas mixture to about ambient temperature; and
d) introducing the first gas mixture to a gas storage system for storage.

7. The method of claim 6, wherein the reactor is not in fluid communication with the semiconductor processing chamber.

8. The method of claim 6, further comprising reacting the first gas mixture by either heating the first gas mixture to a temperature between about 300° C. and about 1000° C., or by exposing the first gas mixture to a plasma.

9. The method of claim 8, further comprising heating the first gas mixture to a temperature between about 400° C. and about 700° C.

10. The method of claim 1, further comprising pre-treating the first gas mixture at a location substantially removed from the location of the chamber.

11. The method of claim 1, further comprising pre-treating the first gas mixture at least about a day before flowing the pre-treated first gas mixture through the chamber.

12. The method of claim 1, further comprising storing the pre-treated first gas mixture in the gas storage device for at least about 12 hours before flowing the pre-treated first gas mixture through the chamber.

13. The method of claim 1, wherein flowing the pre-treated first gas mixture comprises flowing the pre-treated gas mixture at a flow rate between about 1 and about 10 standard liters per minute.

14. The method of claim 1, wherein the undesired substance comprises at least one member selected from the group consisting of:
a) SiO2;
b) SiN;
c) SiON;
d) polysilicon;
e) amorphous silicon;
f) microcrystal silicon; and
g) mixtures thereof:

15. The method of claim 14, wherein the first temperature is between 50° C. and 500° C.

16. The method of claim 15, wherein the first temperature is between 50° C. and 300° C.

17. The method of claim 1, wherein the first temperature is between 50° C. and 500° C.

18. The method of claim 1, wherein the undesired substance is phosphosilicate glass (PSG) or borophosphosilicate glass (BPSG).

19. The method of claim 1, wherein the undesired substance comprises at least one member selected from the group consisting of:
a) Ta;
b) TaN;
c) TaO;
d) TaON; and
e) mixtures thereof.

20. The method of claim 1, wherein the undesired substance comprises at least one member selected from the group consisting of:
a) Ti;
b) TiN;
c) TiO;
d) TiON; and
e) mixtures thereof.

21. The method of claim 1, wherein the undesired substance comprises at least one member selected from the group consisting of:
a) HfO₂;
b) HfN;
c) HfON;
d) HfSiOx;
e) HfSiN;
f HfSiON; and
g) mixtures thereof.

22. The method of claim 1, wherein the undesired substance comprises at least one member selected form the group consisting of:
a) W;
b) WOx;
c) WNx;
d) WON;
e) WSiO;
f) WSiN;
g) WSiON; and
h) mixtures thereof.

23. The method of claim 1, wherein the undesired substance comprises at least one member selected from the group consisting of:
a) ZrO₂;
b) ZrN;
c) ZrON;
d) ZrSiOx;
e) ZrSiN;
f) ZrSiON; and
g) mixtures thereof.
